(19) United States
(12) Patent Application Publication
(10) Pub. No.: US 2026/0154679 A1
(43) Pub. Date: Jun. 4, 2026

(54) SMART CONTRACT GENERATOR

(71) Applicant: Bank of America Corporation, Charlotte, NC (US)

(72) Inventors: Gregory Barrett, Charlotte, NC (US); Rachel A. Lauck, Scranton, PA (US); Duncan Edward Lodge, London (GB); Mark D. Zanzot, Charlotte, NC (US); Teela Phuong Yung, Los Angeles, CA (US)

(21) Appl. No.: 18/965,052

(22) Filed: Dec. 2, 2024

(51) Int. Cl. G06Q 20/38

(52) U.S. Cl. CPC G06Q 20/389

(57) ABSTRACT

Apparatus, methods and systems for leveraging artificial intelligence to generate and enforce a tripartite smart contract are provided. A contract executor may receive a command from an applicant to generate a tripartite smart contract between the applicant and a beneficiary. The contract executor may generate input fields that request information from the applicant. The contract executor may identify one or more successfully executed tripartite smart contracts that include data that corresponds to inputs received from the applicant. The contract executor may generate an executable tripartite smart contract using terminology associated with the identified successfully executed tripartite smart contracts and the inputs. The executable tripartite smart contract may be transmitted to the applicant, the beneficiary and the contract executor for signing. In response to receiving a signature from the applicant, the beneficiary and an entity associated with the contract executor, an issued tripartite smart contract may be generated.

### FIELD OF TECHNOLOGY

Aspects of the disclosure relate to smart contracts and artificial intelligence.

### BACKGROUND OF THE DISCLOSURE

Trade documents, such as trade letters of credit (“LCs”), documentary credits, standby letters of credit (“SBLC”) and guarantees, are used to facilitate international trade. An LC is an instrument issued by a financial institution on behalf of an applicant (generally a buyer of goods/services) and a beneficiary (generally a supplier of the goods/services). The trade document ensures that the beneficiary is paid for the purchased goods/services when specified criteria included in the trade document are met, reviewed and approved by the financial institution. These criteria often include a description of goods/services, purchase date, purchase amount and other data elements.

The beneficiary provides proof of the specified criteria by delivering documents such as invoices, customs and shipping documentation and any other suitable certified documents to the financial institution. Once the criteria of the trade document are met, the financial institution is obligated to pay the beneficiary the amount stated in the trade document.

Trade documents provide a level of security to both applicants and beneficiaries, in that the contract included in the trade document ensures that the applicant receives the goods/services ordered and that the beneficiary is ensured payment upon satisfying the delivery of the goods/services.

LCs, as well as other trade documents, are complex documents to draft. If not drafted properly, LCs and other trade documents can result in discrepancies between the applicant, beneficiary and the financial institution.

Further, many applicants use trade documents infrequently and therefore have limited knowledge of the standards for these trade documents. This results in documents that are incomplete (e.g., missing key terms, language) or improperly formatted. If the trade document is improperly formatted or missing terms it creates a greater risk for both the financial institution and the beneficiary. When the trade document is not properly formatted or is missing terms, the negotiation time may be extended and therefore may increase the costs for the applicant, the beneficiary and the financial institution as they negotiate to update and create a more complete trade document.

Therefore, it may be desirable to provide a system that uses artificial intelligence (“AI”) to create an executable form that is configured to receive details of the transaction between the applicant and beneficiary and generate a trade document including the proper language and formatting. This executable form may present the applicant with a series of steps to ensure that the final trade document aligns with the terms most commonly used for LCs.

The executable form may therefore improve adherence of trade documents with the standards, making it easier to both draft the trade document and to facilitate confirmation of proof-of-delivery documents prior to execution of the trade document.

### SUMMARY OF THE DISCLOSURE

Systems, apparatus and methods for generating and enforcing a tripartite smart contract are provided.

The methods may leverage artificial intelligence (“AI”).

The methods may include regulating a transaction between an applicant and a beneficiary. The methods may include regulating the transaction between the applicant and the beneficiary via a third-party entity. The third-party entity may generate the tripartite smart contract to regulate the transaction. The transaction may be an international transaction.

The applicant may be a receiver of goods/services from the beneficiary. The beneficiary may provide the goods/services in exchange for resources from the applicant. The tripartite smart contract may outline terms and conditions of the transfer of goods/services and resources between the applicant and the beneficiary. The third-party entity may serve as a mutual approver for both the transfer of goods/services and the transfer of resources. The third-party entity may be a financial institution. The third-party entity may be any suitable entity.

Tripartite smart contracts may include commercial letters of credit (“LCs”), guarantees, standby letters of credit (“SBLCs”) and any other suitable trade documents.

LCs follow a set of international guidelines originally drafted by the International Chamber of Commerce (“ICC”). The international guidelines have been updated several times over the years, including the Uniform Customs and Practice for Documentary Credits, or UCP 600, which was released in 2007. Guarantees follow the Universal Rules for Demand Guarantees (URDG 758) drafted and adopted by the ICC in 1991. SBLCs are governed by International Standby Practices (ISP98) published by the ICC in 1998. These three formats (i.e., UCP 600, URDG 758 and ISP98) are widely used and highly regarded international standards related to global trade.

These standards define the specific terms, formatting, and language that is used to draft trade documents. LCs, SBLCs and guarantees may be used for many different purposes including construction projects, real estate purchases, lawsuit settlements, leases, cover insurance premiums, sale of goods, services, etc. There may be standard language to include in the LC, guarantee or SBLC. The standard language may depend on the type of LC, guarantee or SBLC. As such, there may be standard language for leases or advance payment guarantees. In addition, some beneficiaries or industries may have specific language/format/wording to include in LCs, SBLCs and guarantees. The beneficiaries may include insurance companies and/or government agencies, such as the Environmental Protection Agency, the Transportation Department or any other suitable government agency.

LCs, SBLCs and guarantees may have varying complexities. Simple LCs may contain basic terms and requirements. More complex LCs may contain many conditions and requirements, such as, for example, auto extension, reduction schedules, transferability, etc. The formatting/language of LCs, SBLCs and guarantees may be approved by the beneficiary, the applicant and third-party entity.

The methods may include operating a contract executor on a processor. The contract executor may be associated with the third-party entity. The processor may include an AI engine. The processor may be included in a computing device. The computing device may be a desktop computer, a server, a laptop, a tablet, a mainframe computer, a smartphone and/or any other suitable computing device.

The AI engine may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI engine may update the progressive learning algorithms based on the generated outputs curated/retrieved from the analyzed correlations and patterns.

The AI engine may include machine learning algorithms. Machine learning algorithms may enable the AI engine to learn from experience without specific instructional programming. The AI engine may include deep learning algorithms. Deep learning algorithms may utilize neural networks. Neural networks may use interconnected nodes or neurons in a layered structure to analyze data and generate outputs.

The contract executor may include a software application. The software application may be operated using the AI engine.

The contract executor may receive a command from an applicant to generate a tripartite smart contract between the applicant and the beneficiary.

In response to receiving the command, the methods may include generating an applicant profile. The applicant profile may be generated using data associated with the applicant. The data associated with the applicant may be retrieved from one or more databases. The one or more databases may be operated by the third-party entity. The data associated with the applicant may be publicly available data. The publicly available data may be retrieved from any suitable public source. The data associated with the applicant may include a jurisdiction in which the applicant operates, such as a location, region and/or country. The data associated with the applicant may include a financial status of the applicant, such as net worth, an amount of available resources, revenue and/or assets. The data associated with the applicant may include an industry related to the applicant, such as, for example, a financial support industry, a service provider industry, a goods provider industry or any other suitable industry.

In response to receiving the command, the methods may include generating a beneficiary profile. The beneficiary profile may be generated using data associated with the beneficiary. The data associated with the beneficiary may be retrieved from the one or more databases. The data associated with the beneficiary may be publicly available data. The publicly available data may be retrieved from any suitable public source. The data associated with the beneficiary may include a jurisdiction in which the beneficiary operates, such as a location, region and/or country. The data associated with the applicant may include a financial status of the beneficiary, such as net worth, an amount of available resources, revenue and/or assets. The data associated with the beneficiary may include an industry related to the beneficiary, such as, a financial support industry, a service provider industry, a goods provider industry or any other suitable industry.

The methods may include generating a first set of input prompts. The first set of input prompts may request a first set of information from the applicant. The methods may include generating a first set of input fields corresponding to the first set of input prompts. The first set of input fields may receive the first set of information from the applicant. The methods may include using the applicant profile to determine the first set of input prompts corresponding to the identified jurisdiction, industry and financial status of the applicant. The methods may include using the beneficiary profile to determine first set of input prompts corresponding to the identified jurisdiction, industry and financial status of the beneficiary.

The first set of input prompts may request applicant's/corresponding company's legal name and address. The first set of input prompts may request beneficiary's/corresponding company's legal name and address. The first set of input prompts may request a description of the transaction, including goods, services and resources, to be transferred. The first set of input prompts may request an expected delivery/execution date and location for the goods/services. The first set of input prompts may request a contract expiration date. The first set of input prompts may request what documents should be included in the contract. The first set of input prompts may request any other suitable information.

The applicant may respond to the first set of input prompts. The applicant may respond by feeding first inputs into the first set of input fields. The first inputs may be input via text, voice, scan or any other suitable input method. The methods may include receiving the first inputs from the applicant in the first set of input fields.

Methods may include assessing the first inputs, the applicant profile and the beneficiary profile to determine whether to request additional information from the applicant. The methods may include using decision trees to assess the first inputs, the applicant profile and the beneficiary profile. The decision trees may be used to ensure that sufficient information is captured to generate a tripartite smart contract. The decision trees may be used to identify that not sufficient information was captured. In response to such a determination, the methods may include generating second set of input prompts. The second set of input prompts may request a second set of information from the applicant. The second set of input prompts may be based on the first inputs.

For example, a first input prompt may ask the user whether a partial draw is allowed. A partial draw may be when the beneficiary only provides a subset or a portion of the goods/services in return for receipt of a portion of the resources. An example of a partial draw is when the beneficiary delivers one of three shipments and is given a partial payment. In response to receiving a first input from the applicant indicating that partial draws are allowed, the contract executor may generate a second prompt requesting additional information. The additional information may include what conditions are required for partial payment, whether there is a minimum payment required and any other suitable additional information relating to partial draws.

Methods may include generating a second set of fields corresponding to the second set of input prompts. The second set of fields may receive the second set of information from the applicant.

The applicant may respond to the second set of input prompts. The applicant may respond by feeding second inputs into the second set of input fields. The second inputs may be input via text, voice, scan or any other suitable input method. The methods may include receiving the second inputs from the applicant in the second set of input fields.

Methods may include validating the first inputs and the second inputs. Validating the first inputs and the second inputs may include ensuring that the applicant's legal company name and address is an exact match to the legal company name stored in the third-party entity systems. An example of validating the first inputs and the second inputs may include validating that an amount resources is included and that the amount of resources is valid. Another example of validating the first inputs and the second inputs may include validating an expiration date is included and ensuring that the formatting is correct. Validating the first inputs and the second inputs may include any other suitable validation.

The contract executor may be in electronic communication with a first repository. The first repository may store successfully executed tripartite smart contracts. The first repository may store successfully executed tripartite smart contracts that were regulated by the third-party entity. The methods may include identifying, in the first repository, one or more successfully executed tripartite smart contracts that include data determined to correspond to the first inputs and second inputs within a predetermined threshold level of accuracy.

Methods may include generating a tripartite smart contract template. The methods may include generating the tripartite smart contract template using terminology associated with the identified successfully executed tripartite smart contracts. The methods may include generating the tripartite smart contract template using a predetermined format, while adding and/or omitting terminology as determined by the first inputs and the second inputs. In the event that there is required language provided, the methods may include using defined terms for specific trade products, industries and/or countries from the identified successfully executed tripartite smart contracts. In the event that there is no required format, the methods may include generating terminology that may be structured for the type of trade document being generated based on terminology included in the identified successfully executed tripartite smart contracts.

The tripartite smart contract may include placeholders. The placeholders may be used for loading the first inputs and the second inputs. The terminology may include general terminology associated with trade documents. The placeholders may be used for loading applicant, beneficiary, third-party entity and transaction specific information.

Methods may include storing the tripartite smart contract template in a second repository. The second repository may be associated with the third-party entity. The contract executor may be in electronic communication with the second repository. The second repository may be the same as the first repository. The second repository may be different from the first repository.

Methods may include generating an executable tripartite smart contract. The methods may include generating an executable tripartite smart contract by loading the placeholders with the first inputs and the second inputs.

Methods may include transmitting the executable tripartite smart contract to the beneficiary for review. In parallel, the methods may include transmitting the executable tripartite smart contract to the applicant and the third-party entity for review.

Methods may include receiving a reviewed executable tripartite smart contract from the beneficiary including beneficiary-suggested changes. The methods may include receiving a reviewed executable tripartite smart contract from the applicant including applicant-suggested changes. The methods may include receiving a reviewed executable tripartite smart contract from the third-party entity including third-party entity-suggested changes. The methods may include receiving suggested changes from one or more of the beneficiary, the applicant and the third-party entity. The methods may include merging the suggested changes received from the beneficiary, the applicant and/or the third-party entity.

Methods may include verifying that the merged suggested changes are in accordance with the identified successfully executed smart contracts. The methods may include verifying that any suggested changes relating to the terminology are in accordance with standard terminology used in identified successfully executed smart contracts. The methods may include verifying that any suggested changes relating to the first inputs and the second inputs correspond to applicant data included the applicant profile. The methods may include verifying that any suggested changes relating to the first inputs and the second inputs correspond to beneficiary data included in the beneficiary profile.

In response to failing to verify the suggested changes, the methods may include notifying the applicant, the beneficiary and/or the third-party that the suggested changes are not in accordance with the identified successfully executed smart contracts, the applicant profile and/or the beneficiary profile. In response to verifying the suggested changes, the methods may include updating the executable tripartite smart contract with the verified changes. In response to verifying the suggested changes, the methods may include updating the tripartite smart contract template stored in the second repository with the verified changes. In response to verifying the suggested changes, the methods may include updating any pending tripartite contract being regulated by the third-party entity that includes data relating to the suggested changes.

The methods may include transmitting the updated executable tripartite smart contract to the applicant, the beneficiary and the contract executor for signing.

Methods may include deleting the executable tripartite smart contract in response to failing to receive a signature from each of the applicant, the beneficiary and the third-party entity within a given timeframe. The given timeframe may be one or more hours, one or more days, one or more months and/or any other suitable timeframe. The methods may include transmitting a failure-to-issue notification to the applicant in response to failing to receive a signature from each of the applicant, the beneficiary and the third-party entity within the given timeframe. The failure-to-issue notification may request the applicant to review, amend and resign the executable tripartite smart contact. In parallel to transmitting the failure-to-issue notification to the applicant, the methods may include transmitting the failure-to-issue notification to the beneficiary and the third-party entity.

In response to receiving a signature from the applicant, the beneficiary and the contract executor, the methods may include generating an issued tripartite smart contract. The methods may include storing the issued tripartite smart contract in the second repository.

The contract executor may include automation tools to ingest, process, and compare the issued tripartite smart contract to proof-of-delivery documentation provided by the beneficiary. Proof-of-delivery documentation may include documentation that documents the transfer of goods/services from the beneficiary to the applicant. Proof-of-delivery documentation may include receipts, shipping confirmation and/or any other suitable documentation.

For example, since the issued tripartite smart contract specifies the beneficiary's legal name and address, delivery expiry dates, an amount of resources and/or other information, the contract executor may pre-screen proof-of-delivery documentation. Pre-screening the proof-of-delivery documentation with the automation tools may reduce the workload for the third-party entity. The automation tools may include optical character recognition (“OCR”), business process automation and natural language processing tools to compare information within the issued tripartite smart contract and the proof-of-delivery documentation.

The beneficiary may provide the proof-of-delivery documentation to the third-party entity. The contract executor may compare the proof-of-delivery documentation to the issued tripartite smart contract. In response to determining that the proof-of-delivery documentation conforms with the conditions included in the issued tripartite smart contract, the third-party entity may transfer the amount of resources specified in the issued tripartite smart contract from the applicant to the beneficiary.

In response to a notification that the beneficiary and the applicant have completed the transaction, the methods may include storing the issued tripartite smart contract in the first repository, as a successfully executed tripartite smart contract. In response to storing the issued smart contract in the first repository, the methods may include deleting the issued smart contract from the second repository.

The first repository may be used for long-term data storage. The second repository may be used for short-term data storage. The first repository may be a structured repository. The first repository may include metadata tags tagging data stored in the first repository. The second repository may automatically delete data after a predetermined amount of time. The second repository may be a smaller repository than the first repository. The first repository may be linked to the second repository. The second repository may temporarily store a tripartite smart contract. The first repository may permanently store the tripartite smart contract. The tripartite smart contract may be deleted from the second repository prior to storing the tripartite smart contract in the first repository. The tripartite smart contract may be deleted from the second repository after storing the tripartite smart contract in the first repository.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout and in which:

FIG. 1 shows an illustrative diagram in accordance with principles of the disclosure;

FIG. 2 shows another illustrative diagram in accordance with principles of the disclosure;

FIG. 3 shows an illustrative flow chart in accordance with principles of the disclosure;

FIG. 4 shows another illustrative flow chart in accordance with principles of the disclosure;

FIG. 5 shows another illustrative diagram in accordance with principles of the disclosure; and

FIG. 6 shows yet another illustrative diagram in accordance with principles of the disclosure.

### DETAILED DESCRIPTION OF THE DISCLOSURE

Systems, apparatus and methods for generating and enforcing a tripartite smart contract are provided.

The tripartite smart contract may regulate a transaction between an applicant and a beneficiary. The tripartite smart contract may regulate the transaction between the applicant and the beneficiary via a third-party entity. The third-party entity may generate the tripartite smart contract to regulate the transaction. The transaction may be an international transaction.

The applicant may be a receiver of goods/services from the beneficiary. The beneficiary may provide the goods/services in exchange for resources from the applicant. The tripartite smart contract may outline terms and conditions of the transfer of goods/services and resources between the applicant and the beneficiary. The third-party entity may serve as a mutual approver for both the transfer of goods/services and the transfer of resources. The third-party entity may be a financial institution. The third-party entity may be any suitable entity.

Tripartite smart contracts may include commercial letters of credit (“LCs”), guarantees, standby letters of credit (“SBLCs”) and any other suitable trade documents.

The apparatus may include a processor. The processor may execute a contract executor. The contract executor may be associated with the third-party entity. The processor may include an artificial intelligence (“AI”) engine. The processor may be included in a computing device. The computing device may be a desktop computer, a server, a laptop, a tablet, a mainframe computer, a smartphone and/or any other suitable computing device.

The AI engine may include progressive learning algorithms. The progressive learning algorithms may ingest training data. The progressive learning algorithms may analyze the ingested training data. The progressive learning algorithms may analyze the training data for correlations and patterns within the data. The progressive learning algorithms may use the analyzed correlations and patterns to generate outputs. The AI engine may update the progressive learning algorithms based on the generated outputs curated/retrieved from the analyzed correlations and patterns.

The AI engine may include machine learning algorithms. Machine learning algorithms may enable the AI engine to learn from experience without specific instructional programming. The AI engine may include deep learning algorithms. Deep learning algorithms may utilize neural networks. Neural networks may use interconnected nodes or neurons in a layered structure to analyze data and generate outputs.

The contract executor may include a software application. The software application may be operated using the AI engine.

The contract executor may receive a command from an applicant to generate a tripartite smart contract between the applicant and the beneficiary.

In response to receiving the command, the contract executor may generate an applicant profile. The contract executor may generate the applicant profile using data associated with the applicant. The data associated with the applicant may be retrieved from one or more databases. The one or more databases may be operated by the third-party entity. The data associated with the applicant may be publicly available data. The publicly available data may be retrieved from any suitable public source. The data associated with the applicant may include a jurisdiction in which the applicant operates, such as a location, region and/or country. The data associated with the applicant may include a financial status of the applicant, such as net worth, an amount of available resources, revenue and/or assets. The data associated with the applicant may include an industry related to the applicant, such as, for example, a financial support industry, a service provider industry, a goods provider industry or any other suitable industry.

In response to receiving the command, the contract executor may generate a beneficiary profile. The contract executor may generate the beneficiary profile using data associated with the beneficiary. The data associated with the beneficiary may be retrieved from the one or more databases. The data associated with the beneficiary may be publicly available data. The publicly available data may be retrieved from any suitable public source. The data associated with the beneficiary may include a jurisdiction in which the beneficiary operates, such as a location, region and/or country. The data associated with the applicant may include a financial status of the beneficiary, such as net worth, an amount of available resources, revenue and/or assets. The data associated with the beneficiary may include an industry related to the beneficiary, such as, a financial support industry, a service provider industry, a goods provider industry or any other suitable industry.

The contract executor may generate first set of input prompts. The first set of input prompts may request a first set of information from the applicant. The contract executor may generate a first set of input fields corresponding to the first set of input prompts. The first set of input fields may receive the first set of information from the applicant. The contract executor may use the applicant profile to determine the first set of input prompts corresponding to the identified jurisdiction, industry and financial status of the applicant. The contract executor may use the beneficiary profile to determine first set of input prompts corresponding to the identified jurisdiction, industry and financial status of the beneficiary.

The applicant may respond to the first set of input prompts. The applicant may respond by feeding first inputs into the first set of input fields. The first inputs may be input via text, voice, scan or any other suitable input method. The contract executor may receive the first inputs from the applicant in the first set of input fields.

The contract executor may assess the first inputs, the applicant profile and the beneficiary profile to determine whether to request additional information from the applicant. The contract executor may include decision trees. The decision trees may be used to ensure that sufficient information is captured to generate a tripartite smart contract. The decision tree may identify that not sufficient information was captured. In response to such a determination, the contract executor may generate second set of input prompts. The second set of input prompts may request a second set of information from the applicant. The second set of input prompts may be based on the first inputs.

The contract executor may generate a second set of fields corresponding to the second set of input prompts. The second set of fields may receive the second set of information from the applicant.

The applicant may respond to the second set of input prompts. The applicant may respond by feeding second inputs into the second set of input fields. The second inputs may be input via text, voice, scan or any other suitable input method. The contract executor may receive the second inputs from the applicant in the second set of input fields.

The contract executor may be in electronic communication with a first repository. The first repository may store successfully executed tripartite smart contracts. The first repository may store successfully executed tripartite smart contracts that were regulated by the third-party entity. The contract executor may identify, in the first repository, one or more successfully executed tripartite smart contracts that include data determined to correspond to the first inputs and second inputs within a predetermined threshold level of accuracy.

The contract executor may generate a tripartite smart contract template. The contract executor may generate the tripartite smart contract template using terminology associated with the identified successfully executed tripartite smart contracts. The contract executor may generate the tripartite smart contract template using a predetermined format, while adding and/or omitting terminology as determined by the first inputs and the second inputs. In the event that there is required language provided, the contract executor may use defined terms for specific trade products, industries and/or countries from the identified successfully executed tripartite smart contracts. In the event that there is no required format, the contract executor may generate terminology that may be structured for the type of trade document being generated based on terminology included in the identified successfully executed tripartite smart contracts.

The tripartite smart contract may include placeholders. The placeholders may be used for loading the first inputs and the second inputs. The terminology may include general terminology associated with trade documents. The placeholders may be used for loading applicant, beneficiary, third-party entity and transaction specific information.

The contract executor may store the tripartite smart contract template in a second repository. The second repository may be associated with the third-party entity. The contract executor may be in electronic communication with the second repository. The second repository may be the same as the first repository. The second repository may be different from the first repository.

The contract executor may generate an executable tripartite smart contract. The contract executor may generate an executable tripartite smart contract by loading the placeholders with the first inputs and the second inputs.

The contract executor may transmit the executable tripartite smart contract to the beneficiary for review. In parallel, the contract executor may transmit the executable tripartite smart contract to the applicant and the third-party entity for review.

The contract executor may receive a reviewed executable tripartite smart contract from the beneficiary including beneficiary-suggested changes. The contract executor may receive a reviewed executable tripartite smart contract from the applicant including applicant-suggested changes. The contract executor may receive a reviewed executable tripartite smart contract from the third-party entity including third-party entity-suggested changes. The contract executor may not receive suggested changes from any of the beneficiary, the applicant and the third-party entity. The contract executor may receive suggested changes from one or more of the beneficiary, the applicant and the third-party entity. The contract executor may merge the suggested changes received from the beneficiary, the applicant and/or the third-party entity.

The contract executor may verify that the merged suggested changes are in accordance with the identified successfully executed smart contracts. The contract executor may verify that any suggested changes relating to the terminology are in accordance with standard terminology used in identified successfully executed smart contracts. The contract executor may verify that any suggested changes relating to the first inputs and the second inputs correspond to applicant data included the applicant profile. The contract executor may verify that any suggested changes relating to the first inputs and the second inputs correspond to beneficiary data included in the beneficiary profile.

In response to failing to verify the suggested changes, the contract executor may notify the applicant, the beneficiary and/or the third-party that the suggested changes are not in accordance with the identified successfully executed smart contracts, the applicant profile and/or the beneficiary profile. In response to verifying the suggested changes, the contract executor may update the executable tripartite smart contract with the verified changes. In response to verifying the suggested changes, the contract executor may update the tripartite smart contract template stored in the second repository with the verified changes. In response to verifying the suggested changes, the contract executor may update any pending tripartite contract being regulated by the third-party entity that includes data relating to the suggested changes.

The contract executor may transmit the updated executable tripartite smart contract to the applicant, the beneficiary and the contract executor for signing.

The contract executor may delete the executable tripartite smart contract in response to failing to receive a signature from each of the applicant, the beneficiary and the third-party entity within a given timeframe. The given timeframe may be one or more hours, one or more days, one or more months and/or any other suitable timeframes. The contract executor may transmit a failure-to-issue notification to the applicant in response to failing to receive a signature from each of the applicant, the beneficiary and the third-party entity within the given timeframe. The failure-to-issue notification may request the applicant to review, amend and resign the executable tripartite smart contact. In parallel to transmitting the failure-to-issue notification to the applicant, the contract executor may transmit the failure-to-issue notification to the beneficiary and the third-party entity.

In response to receiving a signature from the applicant, the beneficiary and the contract executor, the contract executor may generate an issued tripartite smart contract. The contract executor may store the issued tripartite smart contract in the second repository.

The contract executor may include automation tools to ingest, process, and compare the issued tripartite smart contract to proof-of-delivery documentation provided by the beneficiary. Proof-of-delivery documentation may include documentation that documents the transfer of goods/services from the beneficiary to the applicant. Proof-of-delivery documentation may include receipts, shipping confirmation and/or any other suitable documentation. The automation tools may include optical character recognition (“OCR”), business process automation and natural language processing tools to compare information within the issued tripartite smart contract and the proof-of-delivery documentation.

The beneficiary may provide the proof-of-delivery documentation to the third-party entity. The contract executor may compare the proof-of-delivery documentation to the issued tripartite smart contract. In response to determining that the proof-of-delivery documentation conforms with the conditions included in the issued tripartite smart contract, the third-party entity may transfer the amount of resources specified in the issued tripartite smart contract from the applicant to the beneficiary.

In response to a notification that the beneficiary and the applicant have completed the transaction, the contract executor may store the issued tripartite smart contract in the first repository, as a successfully executed tripartite smart contract. In response to storing the issued smart contract in the first repository, the contract executor may delete the issued smart contract form the second repository.

Illustrative method steps may be combined. For example, an illustrative method may include steps shown in connection with another illustrative method.

The steps of methods may be performed in an order other than the order shown or described herein. Embodiments may omit steps shown or described in connection with illustrative methods. Embodiments may include steps that are neither shown nor described in connection with illustrative methods.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

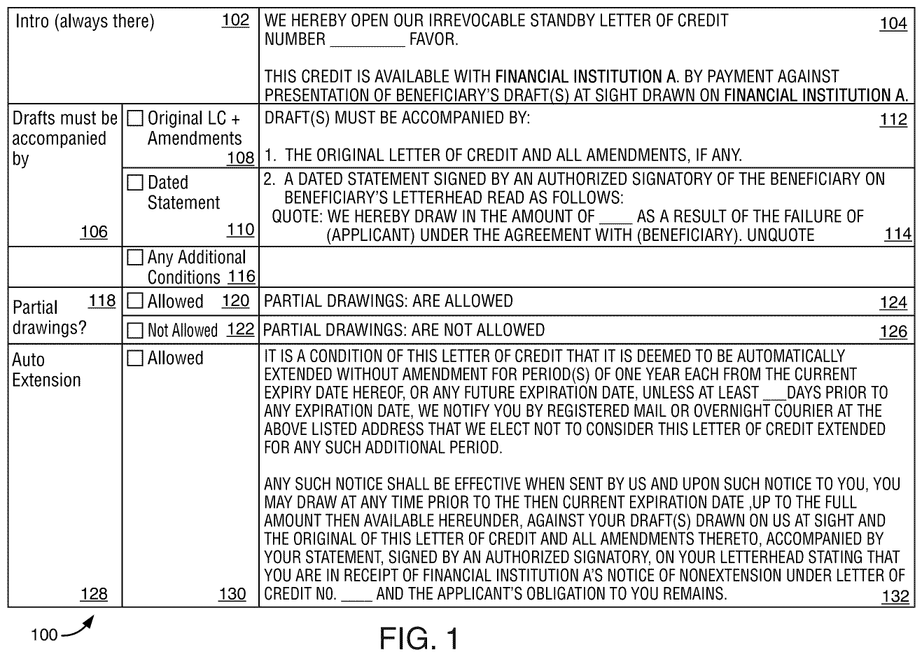

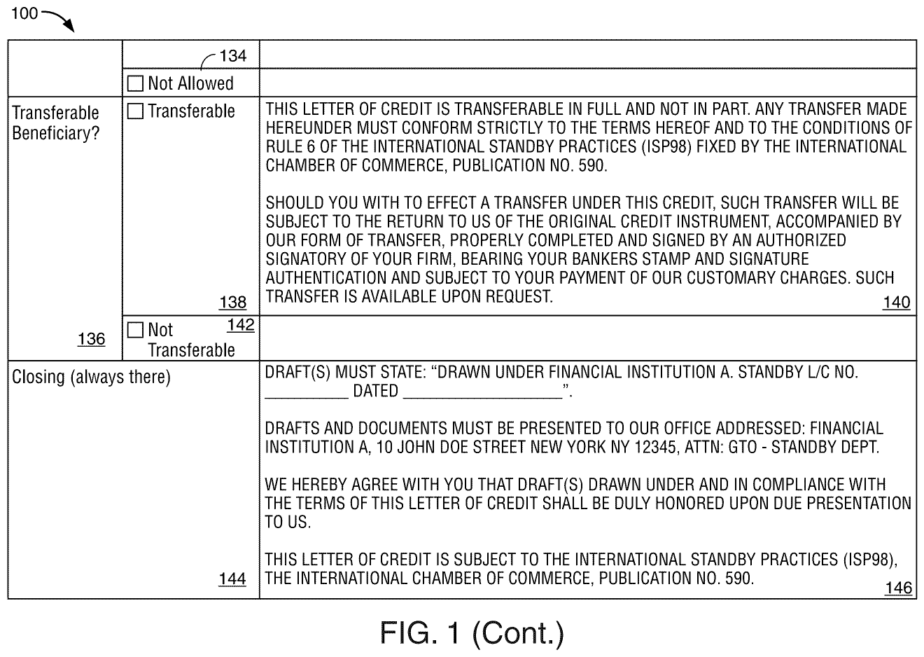

FIG. 1 shows illustrative executable form 100. Executable form 100 may be used to generate a tripartite smart contract between an applicant, a beneficiary and a third-party entity. Executable form 100 may receive information from the applicant. The received information may be used to generate the tripartite smart contract.

Executable form 100 may be an electronic form. Executable form 100 may be displayed on a graphical user interface. Executable form 100 may be displayed on the graphical user interface via a software application. The software application may be operated by the third-party entity.

Executable form 100 may include title fields 102, 106, 118, 128, 136 and 144. Title fields 102, 106, 118, 128, 136 and 144 may label each section of executable form 100 with descriptive text that describes the type of information included within that section. Title fields 102, 106, 118, 128, 136 and 144 may include titles for each data category presented in executable form 100.

Executable form 100 may include input fields 104, 108, 110, 112, 114, 116, 120, 122, 124, 126, 130, 132, 133, 134, 138, 142, 146 and 148. Input fields 104, 108, 110, 112, 114, 116, 120, 122, 124, 126, 130, 132, 133, 134, 138, 142, 146 and 148 may include input prompts requesting information from the applicant. Input fields 104, 108, 110, 112, 114, 116, 120, 122, 124, 126, 130, 132, 133, 134, 138, 142, 146 and 148 may include illustrative trade document text. Input fields 104, 108, 110, 112, 114, 116, 120, 122, 124, 126, 130, 132, 133, 134, 138, 142, 146 and 148 may include selectable options and data receipt fields for receiving information from the applicant. Input fields 104, 108, 110, 112, 114, 116, 120, 122, 124, 126, 130, 132, 133, 134, 138, 142, 146 and 148 may include any combination of input prompts, illustrative trade document text, selectable options and/or data receipt fields.

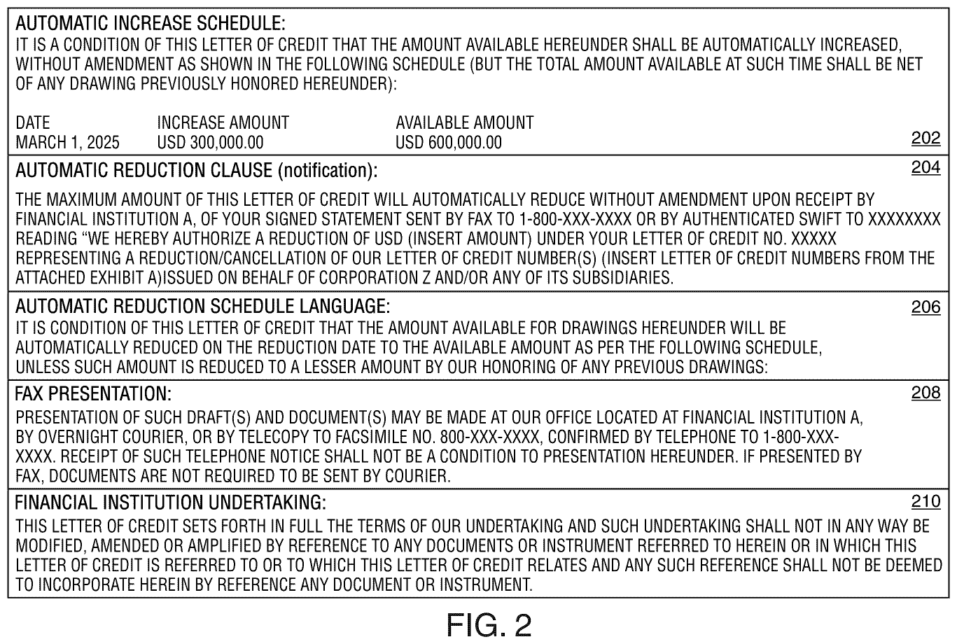

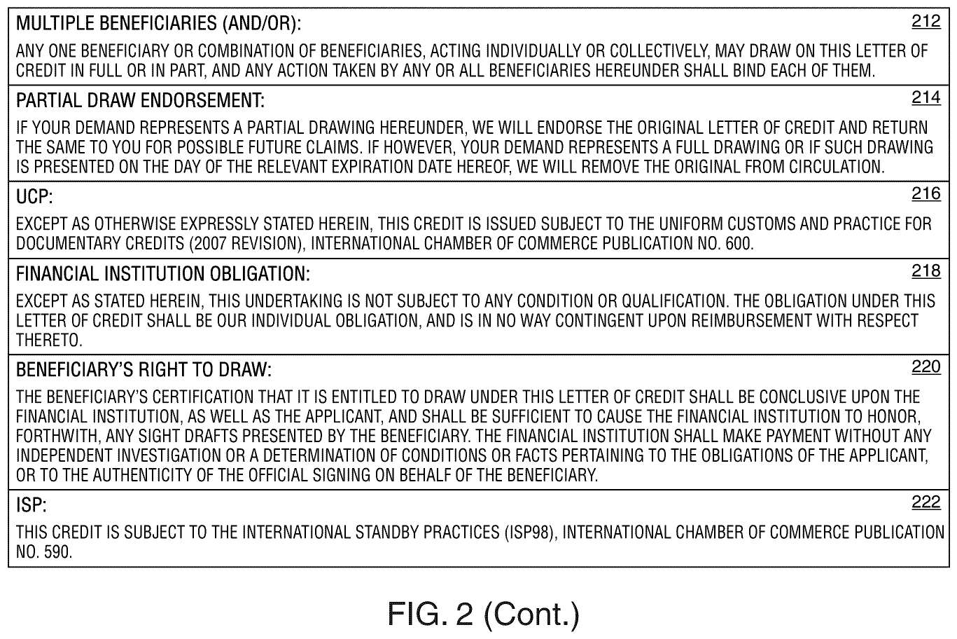

FIG. 2 shows illustrative additional input fields 202, 204, 206, 208, 210, 212, 214, 216, 218, 220, 222. Additional input fields 202, 204, 206, 208, 210, 212, 214, 216, 218, 220, 222 may be included in executable form 100. Additional input fields 202, 204, 206, 208, 210, 212, 214, 216, 218, 220, 222 may be secondary input fields. Additional input fields 202, 204, 206, 208, 210, 212, 214, 216, 218, 220, 222 may be displayed after the applicant inputs a first set of information into first input fields, such as input fields 104, 108, 110, 112, 114, 116, 120, 122, 124, 126, 130, 132, 133, 134, 138, 142, 146 and 148. Additional input fields 202, 204, 206, 208, 210, 212, 214, 216, 218, 220, 222 may be first input fields. Additional input fields 202, 204, 206, 208, 210, 212, 214, 216, 218, 220, 222 may be displayed on the graphical user interface.

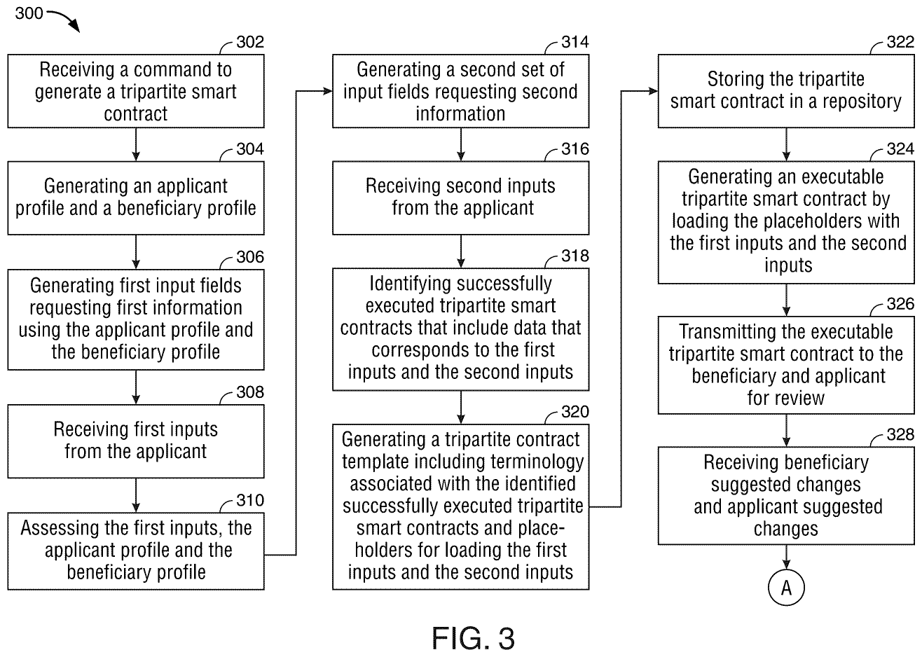

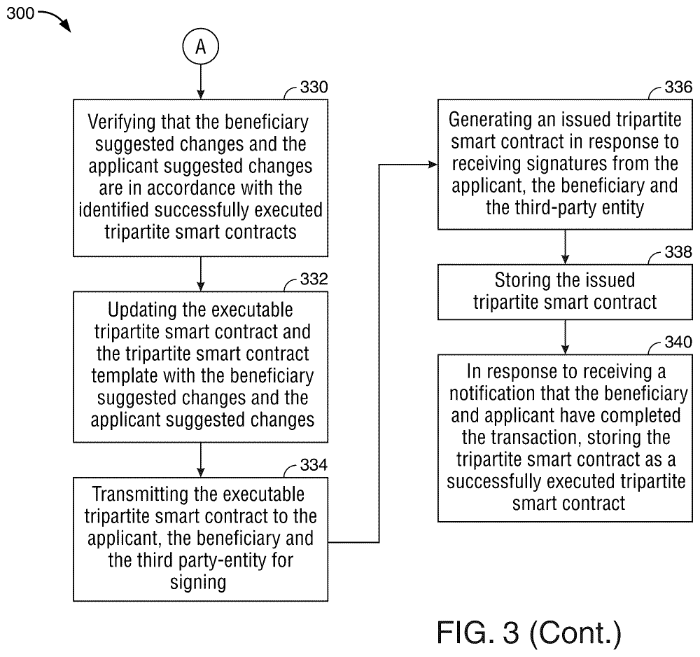

FIG. 3 shows illustrative process 300 for generating a tripartite smart contract between an applicant, a beneficiary and a third-party entity via a contract executor. The tripartite smart contract may regulate a transaction between the applicant and the beneficiary.

At step 302, the contract executor may receive a command from the applicant to generate a tripartite smart contract between the applicant and the beneficiary. The smart contract executor may generate an applicant profile and a beneficiary profile at step 304.

At step 306, the contract executor may generate a first set of input fields requesting a first set of information from the applicant. At step 308, the contract executor may receive first inputs corresponding to the first of input fields from the applicant. The contract executor may assess the first inputs, the applicant profile and the beneficiary profile to determine whether to request additional information from the applicant at step 310.

In response to a determination to request additional information, the contract executor may generate a second set of input fields that request a second set of information from the applicant at step 314. At step 316, the contract executor may receive second inputs corresponding to the second set of input fields from the applicant in the second set of input fields.

At step 318, the contract executor may identify one or more successfully executed tripartite smart contracts that include data determined to correspond to the first inputs and second inputs within a predetermined threshold level of accuracy. At step 320, the contract executor may generate a tripartite smart contract template including terminology associated with the identified successfully executed tripartite smart contracts and placeholders for loading the first inputs and the second inputs.

The contract executor may store the tripartite smart contract template in a repository, at step 322. The contract executor may generate an executable tripartite smart contract by loading the placeholders with the first inputs and the second inputs at step 324.

At step 326 the contract executor may transmit the executable tripartite smart contract to the beneficiary and the applicant for review. The contract executor may receive beneficiary-suggested changes from the beneficiary and applicant-suggested changes from the applicant at step 328.

At step 330, the contract executor may verify that the beneficiary-suggested changes and the applicant-suggested changes are in accordance with the identified successfully executed tripartite smart contracts. The contract executor may update the executable tripartite smart contract and the tripartite smart contract template with the verified changes at step 332.

The contract executor may transmit the updated executable tripartite smart contract to the applicant, the beneficiary and the third-party entity for signing at step 334. At step 336, the contract executor may generate an issued tripartite smart contract in response to receiving a signature from the applicant, the beneficiary and the third-party entity.

At step 338, the contract generator may store the issued tripartite smart contract in the repository. At step 340, the contract generator may store the issued tripartite smart contract as a successfully executed tripartite smart contract, in response to receiving a notification that the beneficiary and applicant have completed the transaction.

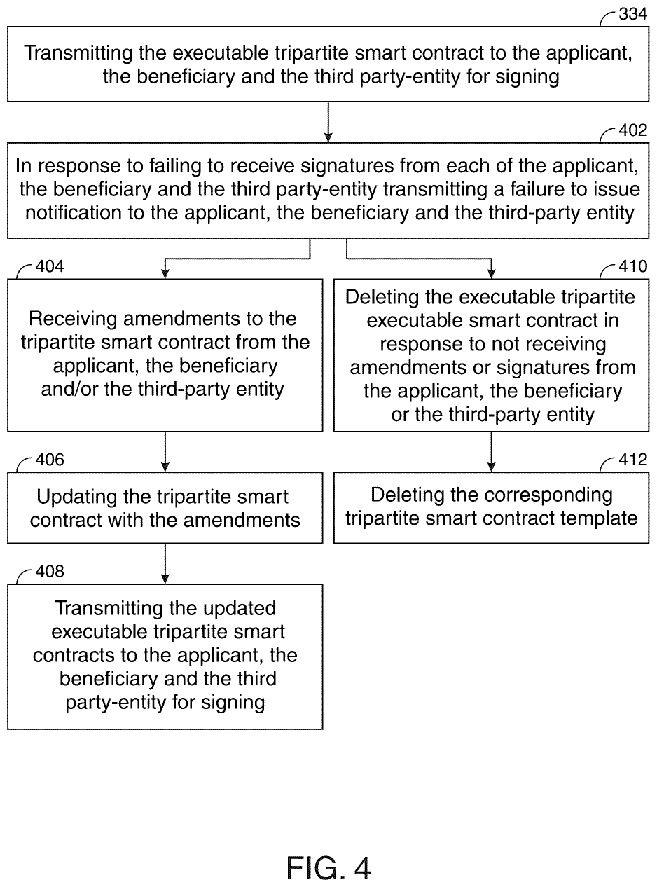

FIG. 4 shows illustrative alternative process that may be included in step 334 of process 300.

After step 334, when the contract executor transmits the executable tripartite smart contract to the applicant, the beneficiary and the third-party entity for signing, step 402 may include transmitting a failure-to-issue notification to the applicant, the beneficiary and the third-party entity in response to failing to receive a signature from any of the applicant, the beneficiary and the third-party entity.

After transmitting the failure-to-issue notification, the contract executor may receive amendments to the tripartite smart contract from the applicant, the beneficiary and/or the third-party entity at step 404. At step 406, the contract executor may update the tripartite smart contract with the amendments. At step 408, the contract executor may transmit the updated executable tripartite smart contract to the applicant, the beneficiary and the third-party entity for signing.

After transmitting the failure-to issue notification, the contract executor may delete the executable tripartite smart contract after failing to receive amendments or signatures from the applicant, the beneficiary and/or the third-party entity at step 410. At step 412, the contract executor may delete the corresponding tripartite smart contract template.

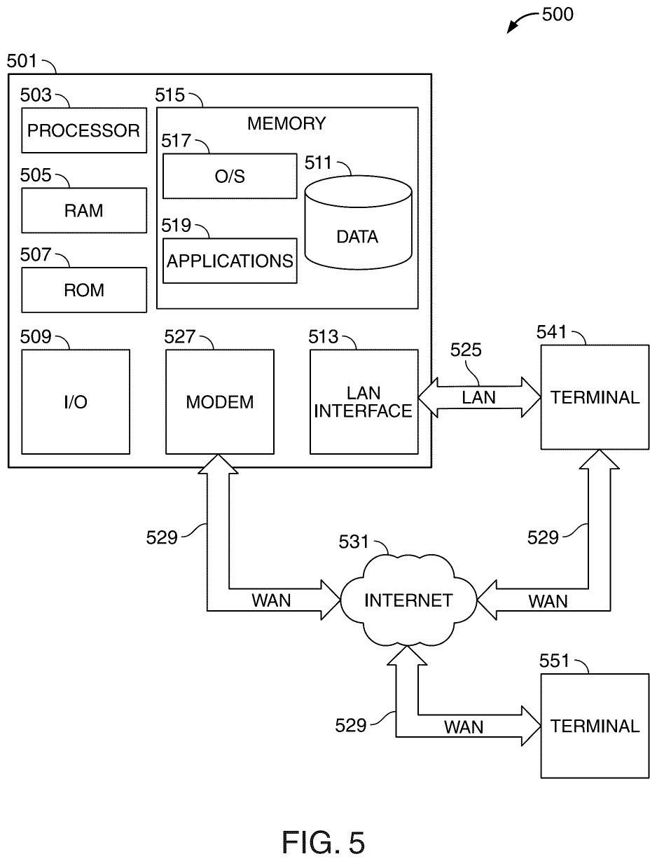

FIG. 5 shows an illustrative block diagram of system 500 that includes computer 501. Computer 501 may alternatively be referred to herein as an “engine,” “server,” or a “computing device.” Computer 501 may be a workstation, desktop, laptop, tablet, smartphone and/or any other suitable computing device. Elements of system 500, including computer 501, may be used to implement various aspects of the systems and methods disclosed herein. Each of the systems, methods and algorithms illustrated above/below may include some or all of the elements and apparatus of system 500.

Computer 501 may include processor 503 for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute software running on the computer. Other components commonly used for computers, such as EEPROM or flash memory or any other suitable components, may also be part of computer 501.

Memory 515 may include any suitable permanent storage technology, such as a hard drive. Memory 515 may store software including the operating system 517 and application program(s) 519 together with any data 511 needed for the operation of the system 500. Memory 515 may also store videos, text and/or audio assistance files. The data stored in memory 515 may also be stored in cache memory and/or any other suitable memory.

I/O module 509 may include connectivity to a microphone, keyboard, touch screen, mouse and/or stylus through which input may be provided into computer 501. The input may include input relating to cursor movement. The input/output module may also include one or more speakers for providing audio output and a video display device for providing textual, audio, audiovisual and/or graphical output. The input and output may be related to computer application functionality.

System 500 may be connected to other systems via a local area network (“LAN”) interface 513. System 500 may operate in a networked environment supporting connections to one or more remote computers, such as terminals 541 and 551. Terminals 541 and 551 may be personal computers or servers that include many or all of the elements described above relative to system 500. The network connections depicted in FIG. 5 include LAN 525 and a wide area network (“WAN”) 529 but may also include other networks. When used in a LAN networking environment, computer 501 may connect to LAN 525 through LAN interface 513 or an adapter. When used in a WAN networking environment, computer 501 may include modem 527 or other means for establishing communications over WAN 529, such as Internet 531.

It will be appreciated if the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory and/or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process received executable instructions, perform power management routines or other suitable tasks.

The invention may be described in the context of computer-executable instructions, such as application(s) 519, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 501 and/or terminals 541 and 551 may also include various other components, such as a battery, speaker and/or antennas (not shown). Components of computer system 501 may be linked by a system bus, wirelessly or by other suitable interconnections. Components of computer system 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone or any other computing system for receiving, storing, transmitting and/or displaying relevant information. Terminal 541 and/or terminal 551 may be one or more user devices. Terminals 541 and 551 may be identical to system 500 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

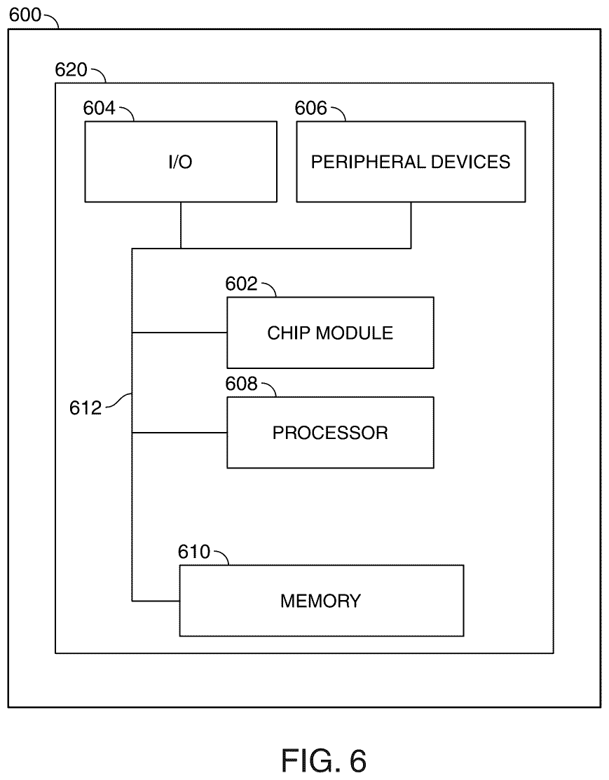

FIG. 6 shows illustrative apparatus 600 that may be configured in accordance with the principles of the disclosure. Apparatus 600 may be a computing device. Apparatus 600 may include one or more features of the apparatus shown in FIG. 5. Apparatus 600 may include chip module 602, which may include one or more integrated circuits, and which may include logic configured to perform any suitable logical operations.

Apparatus 600 may include one or more of the following components: I/O circuitry 604, which may include a transmitter device and a receiver device and may interface with fiber optic cable, coaxial cable, telephone lines, wireless devices, PHY layer hardware, a keypad/display control device or any other suitable media or devices; peripheral devices 606, which may include counter timers, real-time timers, power-on reset generators or any other suitable peripheral devices; logical processing device 608, which may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 519, signals, and/or any other suitable information or data structures.

Components 602, 604, 606, 608, and 610 may be coupled together by a system bus or other interconnections 612 and may be present on one or more circuit boards such as circuit board 620. In some embodiments, the components may be integrated into a single chip. The chip may be silicon-based.

Thus, methods and apparatus for a SMART CONTRACT GENERATOR are provided. Persons skilled in the art will appreciate that the present disclosure can be practiced by other than the described embodiments, which are presented for purposes of illustration rather than of limitation and that the present disclosure is limited only by the claims that follow.

What is claimed is:

1. A method for leveraging artificial intelligence (“AI”) to employ historical data to generate and enforce a tripartite smart contract, the tripartite smart contract configured to regulate execution of a transaction, the method comprising operating a contract executor on a processor, the processor including an AI engine, the contract executor configured for:
receiving a command from an applicant to generate a tripartite smart contract between the applicant and a beneficiary;
in response to receiving the command, generating:
an applicant profile using data associated with the applicant;
a beneficiary profile using data associated with the beneficiary; and
a first set of input fields that request a first set of information from the applicant;
receiving first inputs from the applicant in the first set of input fields;
assessing the first inputs, the applicant profile and the beneficiary profile to determine whether to request additional information from the applicant;
in response to a determination to request additional information, generating a second set of input fields that request a second set of information from the applicant;
receiving second inputs from the applicant in the second set of fields;
identifying, in a first repository storing successfully executed tripartite smart contracts, one or more successfully executed tripartite smart contracts that include data determined to correspond to the first inputs and second inputs within a predetermined threshold level of accuracy;
generating a tripartite smart contract template using terminology associated with the identified successfully executed tripartite smart contracts, the tripartite smart contract template including placeholders for loading the first inputs and the second inputs;
storing the tripartite smart contract template in a second repository associated with the third-party entity;
generating an executable tripartite smart contract by loading the placeholders with the first inputs and the second inputs;
transmitting the executable tripartite smart contract to the beneficiary for review;
receiving a reviewed executable tripartite smart contract from the beneficiary including suggested changes;
verifying that the suggested changes are in accordance with the identified successfully executed tripartite smart contracts;
in response to verifying the suggested changes, updating the executable tripartite smart contract and the tripartite smart contract template stored in the second repository with the verified changes;
transmitting the updated executable tripartite smart contract to the applicant, the beneficiary and a third-party entity associated with the contract executor for signing;
in response to receiving a signature from the applicant, the beneficiary and the third-party entity, generating an issued tripartite smart contract; and
storing the issued tripartite smart contract in the second repository.

2. The method of claim 1 further comprising:
using the beneficiary profile, identifying:
a jurisdiction in which the beneficiary operates;
an industry related to the beneficiary; and
a financial status of the beneficiary; and
determining first input fields corresponding to the identified jurisdiction, industry and financial status.

3. The method of claim 1 further comprising:
using the applicant profile, identifying:
a jurisdiction in which the applicant operates;
an industry related to the applicant; and
a financial status of the applicant; and
determining first input fields corresponding to the identified jurisdiction, industry and financial status.

4. The method of claim 1 further comprising deleting the executable tripartite smart contract in response to failing to receive a signature from each of the applicant, the beneficiary and the third-party entity within a given timeframe.

5. The method of claim 1 further comprising transmitting a failure-to-issue notification to the applicant in response to failing to receive a signature from each of the applicant, the beneficiary and the third-party entity within a given timeframe, the failure-to-issue notification requesting the applicant to review and amend the executable tripartite smart contact.

6. The method of claim 5 further comprising transmitting the failure-to-issue notification to the beneficiary in parallel to transmitting the failure-to-issue notification to the applicant.

7. The method of claim 1 further comprising:
transmitting the executable tripartite smart contract to the applicant for review in parallel to transmitting the executable tripartite smart contract to beneficiary for review; and
merging suggested changes received from the beneficiary and suggested changes received from the applicant.

8. The method of claim 1 wherein in response to a notification that the beneficiary and the applicant have completed the transaction, storing the issued tripartite smart contract in the first repository as a successfully executed tripartite smart contract.

9. The method of claim 8 wherein in response to storing the issued tripartite smart contract in the first repository, deleting the issued tripartite smart contract from the second repository.

10. The method of claim 1 wherein in response to receiving a suggested change that is in accordance with the identified successfully executed tripartite smart contracts, updating any pending tripartite smart contract being regulated by the third-party entity that includes data relating to the suggested change.

11. Apparatus for leveraging artificial intelligence (“AI”) to employ historical data to generate and enforce a tripartite smart contract, the tripartite smart contract configured to regulate execution of a transaction, the apparatus comprising:
a first repository configured to store successfully executed tripartite smart contracts;
a contract executor operating on a processor, the processor including an artificial intelligence (“AI”) engine, the contract executor being associated with a third-party entity, the contract executor configured to manage the tripartite smart contract, the contract executor configured to:
receive a command from an applicant to generate the tripartite smart contract between the applicant and a beneficiary;
in response to receiving the command, generate:
an applicant profile using data associated with the applicant;
a beneficiary profile using data associated with the beneficiary; and
a first set of input fields that request a first set of information from the applicant;
receive first inputs from the applicant in the first set of input fields;
assess the first inputs, the applicant profile and the beneficiary profile to determine whether to request additional information from the applicant;
in response to a determination to request additional information, generate a second set of input fields that request a second set of information from the applicant;
receive second inputs from the applicant in the second set of fields;
identify, in the first repository, one or more successfully executed tripartite smart contracts that include data determined to correspond to the first inputs and the second inputs within a predetermined threshold level of accuracy; and
generate a tripartite smart contract template using terminology associated with the identified successfully executed tripartite smart contracts, the tripartite smart contract template including placeholders for loading the first inputs and the second inputs; and
a second repository configured to store the tripartite smart contract template, the second repository configured to be in electronic communication with the contract executor;
wherein the contract executor is further configured to:
generate an executable tripartite smart contract by loading the placeholders with the first inputs and the second inputs;
transmit the executable tripartite smart contract to the beneficiary for review;
receive a reviewed executable tripartite smart contract from the beneficiary including suggested changes;
verify that the suggested changes are in accordance with the identified successfully executed tripartite smart contracts;
in response to a verification of the suggested changes, update the executable tripartite smart contract and the smart contract template stored in the second repository with the verified changes;
transmit the updated executable tripartite smart contract to the applicant, the beneficiary and the third-party entity for signing;
in response to receipt of a signature from the applicant, a signature from the beneficiary and a signature from the third-party entity associated with the contract executor, generate an issued tripartite smart contract; and
store the issued tripartite smart contract in the second repository.

12. The apparatus of claim 11 wherein the contract executor is further configured to:
use the beneficiary profile to identify:
a jurisdiction in which the beneficiary operates; and
a financial status of the beneficiary; and
determine first input fields corresponding to the identified jurisdiction and financial status.

13. The apparatus of claim 11 wherein the contract executor is further configured to:
use the applicant profile to identify:
a jurisdiction in which the applicant operates; and
a financial status of the applicant; and
determine first input fields corresponding to the identified jurisdiction and financial status.

14. The apparatus of claim 11 wherein the contract executor is further configured to delete the executable tripartite smart contract in response to failing to receive a signature from each of the applicant, the beneficiary and the third-party entity within a given timeframe.

15. The apparatus of claim 11 wherein the contract executor is further configured to transmit a failure-to-issue notification to the applicant in response to failing to receive a signature from each of the applicant, the beneficiary and the third-party entity within a given timeframe, the failure-to-issue notification configured to request the applicant to review and amend the executable tripartite smart contact.

16. The apparatus of claim 15 wherein the contract executor is further configured to transmit the failure-to-issue notification to the beneficiary in parallel with transmission of the failure-to-issue notification to the applicant.

17. The apparatus of claim 11 wherein the contract executor is further configured to:
transmit the executable tripartite smart contract to the applicant for review in parallel to transmission of the executable tripartite smart contract to beneficiary for review; and
merge suggested changes received from the beneficiary and suggested changes received from the applicant.

18. The apparatus of claim 11 wherein in response to receipt of a notification that the beneficiary and the applicant have completed the transaction, the contract executor is further configured to store the issued tripartite smart contract in the first repository as a successfully executed tripartite smart contract.

19. The apparatus of claim 18 wherein in response to storage of the issued tripartite smart contract in the first repository, the contract executor is further configured to delete the issued tripartite smart contract from the second repository.

20. The apparatus of claim 11 wherein in response to receipt of a suggested change that is in accordance with the identified successfully executed tripartite smart contracts, the contract executor is further configured to update any pending tripartite smart contract being regulated by the third-party entity that includes data related to the suggested change.
